(19) United States
(12) Patent Application Publication
(10) Pub. No.: US 2013/0074939 A1
(43) Pub. Date: Mar. 28, 2013

(54) DEVICE FOR ELECTROMECHANICAL ACTUATOR

(71) Applicant: Egil Eriksen, Foldroyhamn (NO)

(72) Inventor: Egil Eriksen, Foldroyhamn (NO)

(21) Appl. No.: 13/639,769

(22) PCT Filed: Apr. 4, 2011
(86) PCT No.: PCT/NO11/00117

§ 371 Date: Dec. 12, 2012

(30) Foreign Application Priority Data
Apr. 7, 2010 (NO) 20100491
Mar. 16, 2011 (NO) 20110403

(51) Int. Cl. F16K 31/00

(52) U.S. Cl. CPC F16K 31/00
USPC 137/1; 251/213

(57) ABSTRACT

A device for a valve actuator is described, the valve actuator being provided with a slide nut surrounding a portion of an actuator slide and being in engagement with an external threaded portion arranged on the actuator slide, the slide nut being axially fixed relative to the actuator slide, and the actuator slide being in rotation-preventing engagement with a portion of an actuator mounting or a valve housing, and the slide nut being connected to a driving motor via transmission means. Also, a method of operating a valve is described, the method including the step of: providing an axial displacement of the actuator slide by rotating a slide nut which surrounds a portion of an actuator slide, is in engagement with an external threaded portion arranged on the actuator slide and is axially fixed relative to the actuator slide, the rotation being provided with the help of at least one driving motor.

The invention relates to a device for a valve actuator, the valve actuator being provided with a slide nut which is in engagement with an external threaded portion of an actuator slide and brings it to be moved axially by the rotation of a driving motor connected to the slide nut via transmission means. Also, a method of operating a valve is described.

In what follows, the function of the actuator is illustrated by the actuator being connected to an underwater choke valve, the actuator being used for quick adjustment of the valve between the closed and open positions and into intermediate positions in order to regulate the flow through the valve.

Actuators with stepped regulation by means of a hydraulic valve operation for controlling underwater choke valves, is generally used. This takes a long time; typically, 180 steps from the open to the closed valve is usual. Several operators in the oil industry have requirements for choke valves to be closed in less than 30 seconds when a well flow is shut down. Quick closing of the choke valve contributes to a gate valve at the outlet of a Christmas tree not closing to a full well flow, thereby hydrate formation can be prevented, and problems with wear in hydraulic control valves by stepped actuation are avoided.

WO/2003/021077 discloses an actuator with a planetary roller screw mechanism which is moved axially via hydraulic actuation and converts the axial motion into rotation of the centre screw.

US 2009/0211762 A1 discloses a modular electric-actuator solution for subsea valves, in which, by rotation of a threaded mandrel on the end of an electromotor axle, a ball nut with an extension sleeve, which surrounds the end of the mandrel when it is in the inner position, is moved.

WO 2006/071124 A1 discloses an electric-actuator solution which transmits the torque from a driving motor to a threaded mandrel which moves a roller nut, which is connected to an actuating mechanism, axially.

The invention has for its object to remedy or reduce at least one of the drawbacks of the prior art, or at least provide a useful alternative to the prior art.

The object is achieved through features which are specified in the description below and in the claims that follow.

A valve actuator is provided, in which the rotation of a slide nut results in an axial movement of an actuator slide which is connected to a valve slide arranged in a valve housing.

In a first aspect the invention relates more specifically to a device for a valve actuator, characterized by
the valve actuator being provided with a slide nut surrounding a portion of an actuator slide and being in engagement with an external threaded portion arranged on the actuator slide, the slide nut being axially fixed relative to the actuator slide;
the actuator slide being in rotation-preventing engagement with a portion of an actuator mounting or a valve housing; and
the slide nut being connected via transmission means to a driving motor.

The at least one driving motor may be an electromotor arranged in a pressure-tight actuator housing.

The valve actuator may be provided with a connecting device for a second, portable driving motor, and the connecting device is in engagement with the slide nut via transmission elements.

The transmission elements may include a friction coupling.

The second, portable driving motor may be a subsea torque tool.

To the slide nut or the transmission means, a position sensor may be connected, arranged to register the rotation of the is slide nut.

In a second aspect, the invention relates more specifically to a method of operating a valve, characterized by the method including the step of:
providing an axial displacement of the actuator slide by rotating a slide nut which surrounds a portion of an actuator slide and which is in engagement with an external threaded portion arranged on the actuator slide and is axially fixed relative to the actuator slide, the rotation being provided with the help of at least one driving motor.

The at least one driving motor may be an electromotor arranged in a pressure-tight actuator housing, and the electromotor is connected to a programmable control system.

The at least one driving motor may be a torque tool arranged on an underwater vehicle and temporarily connected to the transmission elements via an external connecting device.

In what follows is described an example of a preferred embodiment visualized in the accompanying drawings, in which:

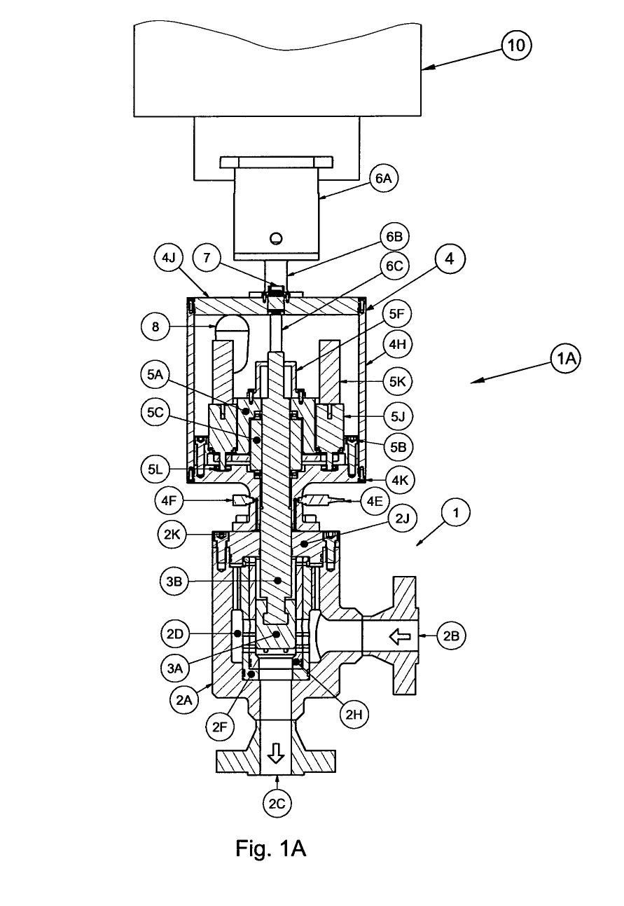

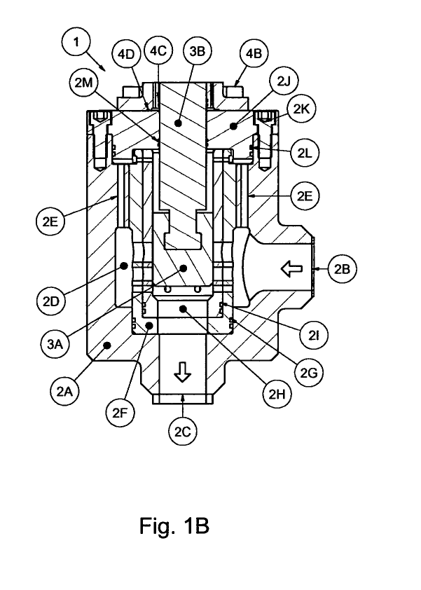

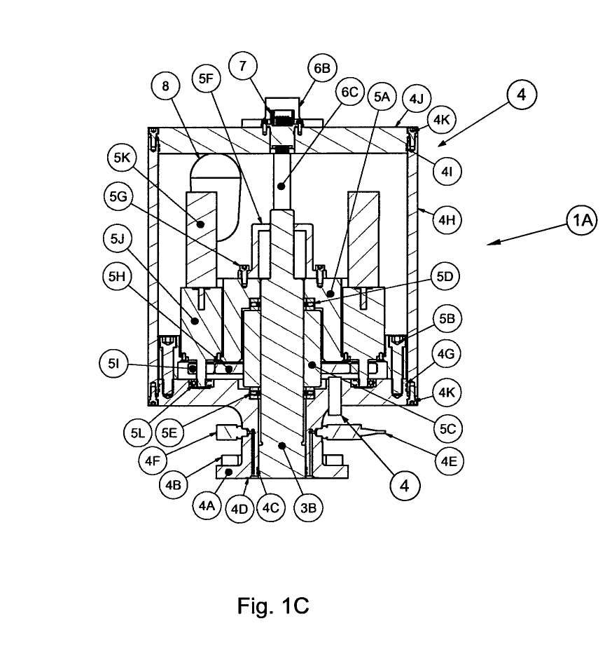

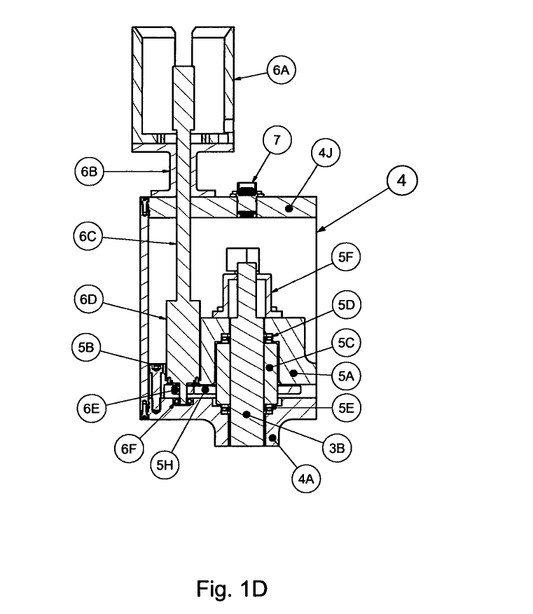

FIG. 1A shows an axial section through a choke valve with a valve actuator according to the invention;

FIG. 1B shows, on a larger scale, an axial section through a valve housing;

FIG. 1C shows an axial section through the valve actuator;

FIG. 1D shows a section of an axial section of the valve actuator—rotated 90° relative to FIGS. 1A and 1C;

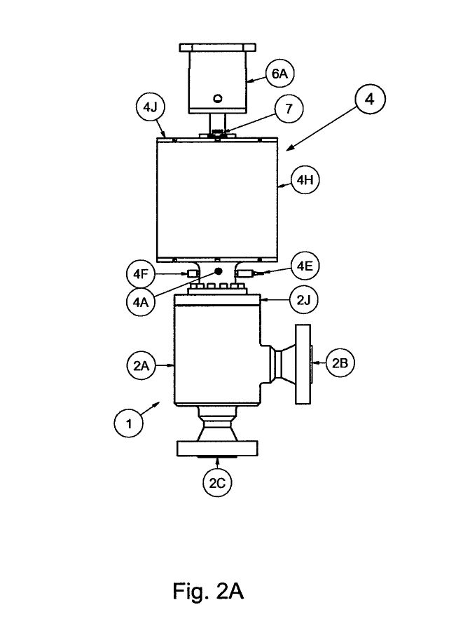

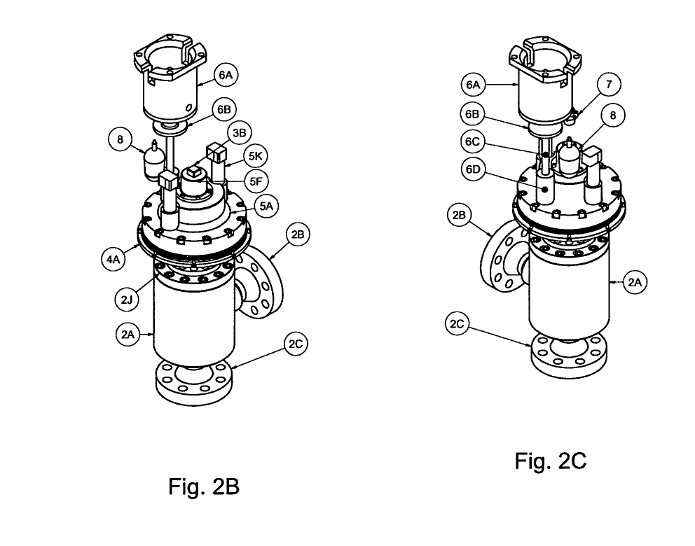

FIG. 2A shows a side view of the choke valve and the valve actuator;

FIG. 2B shows a perspective sketch of the choke valve and is the valve actuator, the valve housing having been removed for reasons of exposition; and

FIG. 2C shows a perspective sketch of the choke valve and the valve actuator rotated 90° relative to FIG. 2B.

In what follows, it is taken for a basis that a valve actuator is used to manoeuvre a choke valve. This does not imply a limitation in the scope of application of the invention, but serves as an example for the explanation of the features included in the invention, which are visualized in the accompanying drawings.

In the drawings, the reference numeral 1 indicates a choke valve with a valve housing 2A with flange connections, known per se, for a supply port 2B and an outlet port 2C, respectively. A valve actuator 1A is arranged in a pressure-tight manner in an actuator housing 4 defined by a mounting flange 4A, an actuator jacket 4H and an end cap 4J.

FIG. 1A shows a longitudinal sectional drawing of the choke valve 1 assembled with the valve actuator 1A. FIG. 1B shows a longitudinal sectional drawing of the valve housing 2A and appurtenant parts.

When liquid from the supply port 2B enters an annular space 2D in the valve housing 2A, the liquid flow is divided into partial liquid streams passing through flow holes in outer and inner sleeves 2F, 2H in the valve housing 2A. The two sleeves 2F, 2H are provided with several sets of holes of different diameters. The partial liquid streams come together internally in the inner sleeve 2H and flow on through the outlet port 2C of the choke valve 1. At the outlet side of the choke valve 1, the outer sleeve 2F is provided with an outer sleeve gasket 2G which seals against the inside of the valve housing 2A. An inner sleeve gasket 2I seals between the inner sleeve 2H and the outer sleeve 2F.

An end cover 2J is attached to the valve housing 2A with attachment screws 2K. Externally on a lower edge around the end cover 2J, a first end cap gasket 2L is arranged, sealing against an internal edge of the valve housing 2A. A valve slide 3A is attached to the end of an actuator slide 3B passing through a centre opening in the end cover 2J. The valve slide 3A can be moved axially in the inner sleeve 2H. A second end cap gasket 2M arranged in the centre opening of the end cover 2J seals against the actuator slide 3B. The valve slide 3A is pressure-balanced by the annular space between the actuator slide 3B and the internal sleeve 2H being connected to the valve housing annular space 2D in the valve housing 2A via channels 2E in the valve housing 2A, bores in the end cover 2J and corresponding holes in the sleeves 2F, 2H.

The valve 1 is open when the valve slide 3A has been moved up against the bottom side of the end cover 2J of the valve housing 2A. When, by axial displacement of the actuator slide 3B, the valve slide 3A is moved through the inner sleeve 2H towards the outlet port 2C of the valve 1, it blocks liquid flow from the annular space 2D through the flow holes of the sleeves 2F, 2H. Intermediate positions of the valve slide 3A completely or partially blocking liquid flow through the flow holes will provide choking of the liquid flow. When the valve slide 3A is moved to an end position in the inner sleeve 2H, it seals against a seat in the inner sleeve 2H, and the valve 1 is closed.

FIG. 1C shows a longitudinal sectional drawing of the valve actuator 1A with the actuator housing 4 and internal actuating devices. A double mounting flange 4A with a through hole for the actuator slide 3B is attached with screws 4B to the end cover 2J of the valve housing 2A. A first mounting flange gasket 4C seals between the bore at the centre of the mounting flange 4A and the actuator slide 3B extending through it. A second mounting flange gasket 4D seals between the mounting flange 4A and the end cover 2J. A possible pressure build-up in the area between the gaskets 4C, 4D owing to leakage between the actuator slide 3B and the end cover 2J is detected by means of a pressure transmitter 4E which is connected to the area between the gaskets 4C, 4D through a bore in the mounting flange 4A. The pressure transmitter 4E is connected to a control system (not shown), and any detection of a leakage is accompanied by an alarm. The mounting flange 4A is also provided with a leakage port from the area between the gaskets 4C, 4D to a check valve 4F which communicates with the surroundings.

A first jacket gasket 4G is arranged between the cylindrical actuator jacket 4H enclosing the actuating devices and the outer edge of the mounting flange 4A, and a second jacket gasket 4I between the actuator jacket 4H and the outer edge of the end cap 4J. The cylindrical actuator jacket 4H is secured with bolts 4K to the outer edge of the mounting flange 4A and the outer edge of the end cap 4J, respectively.

An actuator mounting 5A is secured to the mounting flange 4A with screws 5B. The actuator mounting 5A is formed with a through-going centre bore for the actuator slide 3B and with an internal recess which may accommodate a slide nut 5C and a first slide nut bearing 5D. A second slide nut bearing 5E for the other end of the slide nut 5C is recessed into the actuator mounting 4A. The slide nut SC may be a so-called roller screw nut or ball screw nut, for example.

The actuator slide 3B is formed with an external threaded portion which is in engagement with the slide nut 5C. The end of the actuator slide 3B has a non-circular profile corresponding to a centre opening in an end case 5F and preventing the actuator slide 3B from rotating when the slide nut 5C is set into rotary motion to displace the actuator slide 3B. The slide nut 5C is rotated via a toothed wheel transmission arranged in a recess between the mounting flange 4A and the actuator mounting 5A. The slide nut 5C is provided with an external toothed wheel 5H in mesh with two toothed wheels 5I mounted on the ends of respective slide gears 5J which are each arranged on a first driving motor, typically an electric motor 5K. The slide gears 5J are each provided with a respective support bearing 5L recessed into the mounting flange 4A.

As it appears from the longitudinal sectional drawing 1D, in one embodiment, the slide nut 5C may be rotated by means of a torque tool (see FIG. 1A) on an underwater vehicle (not shown). The torque tool 10 is connected to a connecting device 6A which is mounted on the end cap 4J via a flange 6B. The torque from the torque tool 10 is transmitted to a torque shaft 6C which is connected to a friction coupling 6D which restricts the torque applied. From the friction coupling 6D, an axle extends with a toothed wheel 6E which is in mesh with the external toothed wheel 5H of the slide nut 5C. The toothed wheel transmission is placed in the recess between the mounting flange 4A and the actuator mounting 5A. The axle of the toothed wheel 6E is supported in a support bearing 6F recessed into the mounting flange 4A.

From the outside of the end cap 4J, a cable connection (not shown) runs through a cable bushing 7 for signal transmission and electrical power supply. It may possibly be relevant to have several cable bushings. On the inside of the actuator jacket 4H, several cable connections (not shown) extend between the cable bushing 7 and an electronics container (not shown). The actuator housing 4 is filled with an electrically insulating medium, for example silicone oil, and is pressure-compensated against the surrounding seawater pressure via a pressure compensator 8 known per se.

The actuator is possibly provided with a position sensor (not shown) for registering the turns of the slide nut 5C.

1. A device for a valve actuator, characterized in that
the valve actuator is provided with a slide nut surrounding a portion of an actuator slide and being in engagement with an external threaded portion arranged on the actuator slide, the slide nut being axially fixed relative to the actuator slide;
the actuator slide is in rotation-preventing engagement with a portion of an actuator mounting or a valve housing; and
the slide nut is connected via transmission means with a driving motor.

2. The device according to claim 1, wherein the at least one driving motor is an electromotor arranged in a pressure-tight actuator housing.

3. The device according to claim 1, wherein the valve actuator is provided with a connecting device for a second, portable driving motor, and the connecting device is in engagement with the slide nut via transmission elements.

4. The device according to claim 1, wherein the transmission elements include a friction coupling.

5. The device according to claim 3, wherein the second, portable driving motor is an underwater torque tool.

6. The device according to claim 1, wherein the slide nut or the transmission means are connected to a position sensor arranged to register the rotation of the slide nut.

7. A method of operating a valve, the method includes the step of:
providing an axial displacement of the actuator slide by rotating a slide nut which surrounds a portion of an actuator slide, is in engagement with an external threaded portion arranged on the actuator slide and is axially fixed relative to the actuator slide, the rotation being provided with the help of at least one driving motor.

8. The method according to claim 7, wherein the at least one driving motor is an electromotor arranged in a pressure-tight actuator housing, and the electromotor is connected to a programmable control system.

9. The method according to claim 7, wherein the at least one driving motor is a torque tool arranged on an underwater vehicle and temporarily connected to the transmission elements via an external connecting device for an underwater torque tool.
